(19) United States
(12) Patent Application Publication
(10) Pub. No.: US 2025/0083548 A1
(43) Pub. Date: Mar. 13, 2025

(54) VEHICLE CHARGING SYSTEM AND METHOD

(71) Applicant: Ford Global Technologies, LLC, Dearborn, MI (US)

(72) Inventors: Stuart C. Salter, White Lake, MI (US); Keith Weston, Canton, MI (US); Mark J. Ferrel, Brighton, MI (US); Ryan O'Gorman, Beverly Hills, MI (US); Rob Anthony Richardson, Galleywood / Chelmsford (GB); Brendan Diamond, Grosse Pointe, MI (US)

(21) Appl. No.: 18/463,033

(22) Filed: Sep. 7, 2023

(51) Int. Cl. B60L 53/38; B60L 53/12; B60P 1/44

(52) U.S. Cl. CPC B60L 53/38; B60L 53/12; B60P 1/4414

(57) ABSTRACT

Methods and systems for charging an electric energy storage device of a vehicle are described. In one example, the electric energy storage device is charged via a receiving coil that may be placed in a horizontal orientation or a vertical orientation during charging of the electric energy storage device via the receiving coil.

### FIELD

The present description relates to methods and a system for charging an electric energy storage device of a vehicle. The methods and system may be particularly useful for electric and hybrid vehicles.

### BACKGROUND AND SUMMARY

A vehicle may include an electric energy storage device that provides energy to an electric machine. The electric machine may provide propulsive effort to move the vehicle. The electric energy storage device may be charged from time to time via a stationary power grid. The stationary power grid may supply electric charge to the electric energy storage device via electric vehicle supply equipment (EVSE). In many situations, the EVSE may supply electric power to the vehicle via a cable and a connector that interfaces with an electric port of the vehicle.

It may be understood that the summary above is provided to introduce in simplified form a selection of concepts that are further described in the detailed description. It is not meant to identify key features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The advantages described herein will be more fully understood by reading an example of an example, referred to herein as the Detailed Description, when taken alone or with reference to the drawings, where:

FIG. 1 is a schematic diagram of a non-limiting electric vehicle;

FIGS. 2-5 show views of an example vehicle and a portion of its charging system;

FIGS. 6 and 7 show example displays that allow a vehicle operator to align an electric charge receiving coil with an electric charging coil; and

FIG. 8 shows a flow chart of a method for charging a vehicle via a tail lift charger.

### DETAILED DESCRIPTION

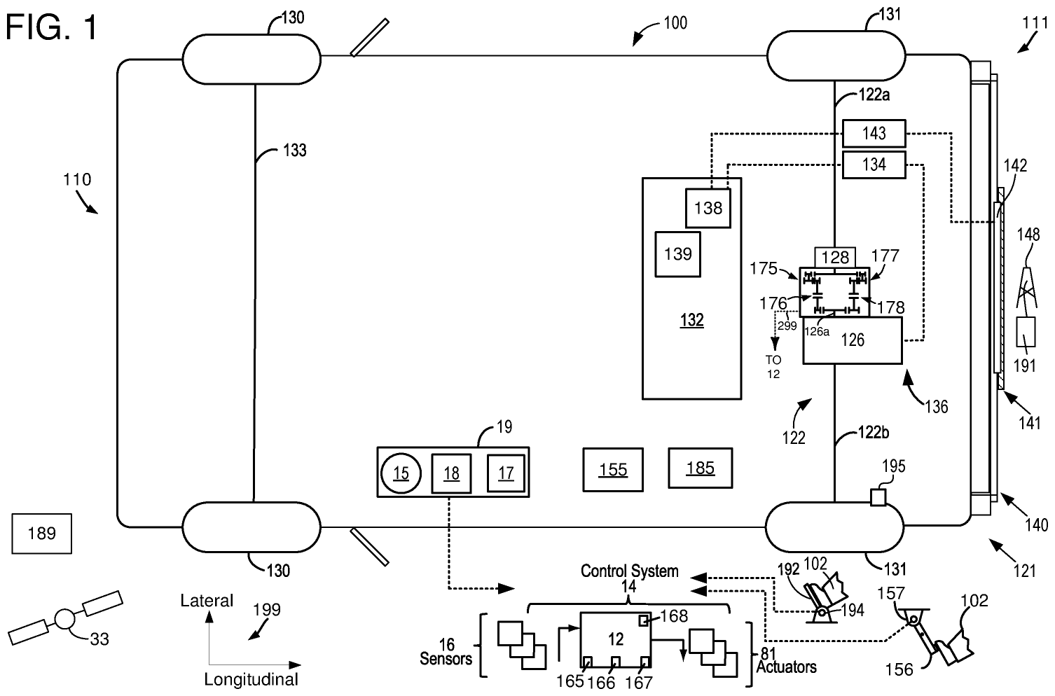

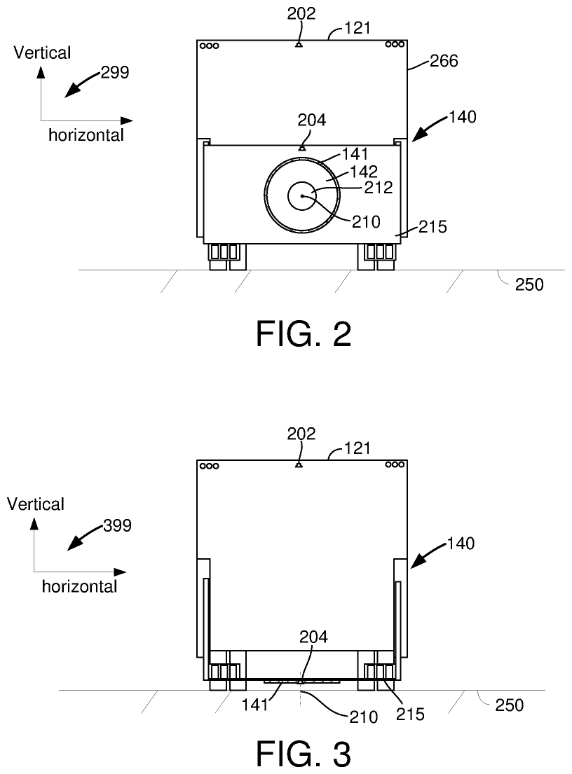

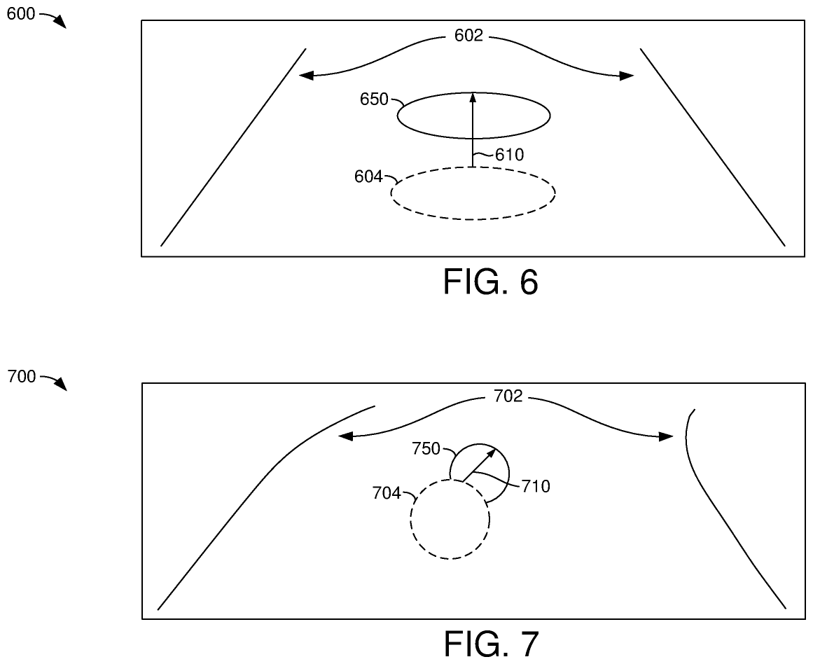

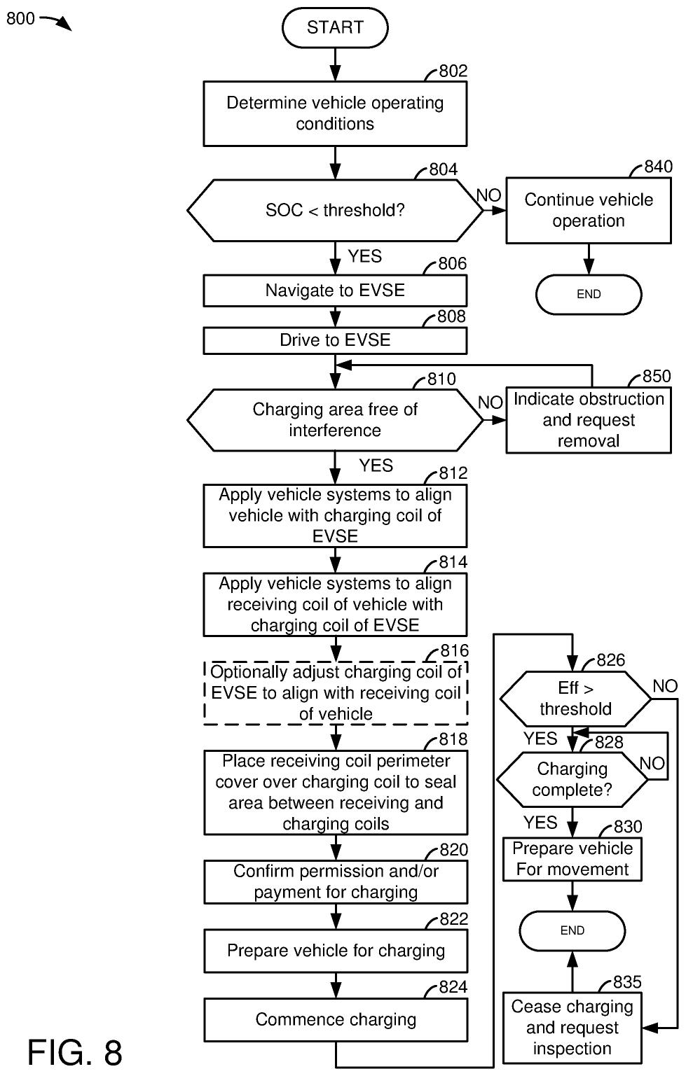

The present description is related to supplying electric charge to an electric vehicle or a hybrid vehicle. In one example, the electric charge is received via a tail lift receiving coil and the electric charge may be transferred to an electric energy storage device (e.g., a battery, capacitor, etc.) via a charger or an inverter. FIG. 1 shows a plan view of an electrified powertrain that includes a receiving coil for receiving electric charge via induction. The receiving coil may be incorporated into a vehicle tail lift that has vertical motion and pivot motion capabilities as shown in FIGS. 2-5. FIGS. 6 and 7 show example displays for assisting a human or autonomous driver to position a receiving coil proximate to a charging coil so that the vehicle may be charged via EVSE. A flow chart of a method for inductively charging a vehicle is shown in FIG. 8.

A vehicle may include a charging port to receive electric charge from EVSE to a vehicle. To receive charge via the charging port, a cable may be extended from the EVSE to the charging port. However, if the vehicle is a delivery vehicle that includes doors, the doors may cover the charging port when the vehicle is being loaded. Further, the charging cords may become stiff and more difficult to insert to the charging port when ambient temperatures fall. Therefore, it may be desirable to provide a way of increasing an amount of charge stored in an electric storage device without having to couple EVSE to a vehicle with a cord.

The inventors herein have recognized the above-mentioned disadvantage and have developed a vehicle charging system, comprising: a vehicle including an electric energy storage device; and a tail lift including a receiving coil for charging the electric energy storage device.

By incorporating a receiving coil into a tail lift of a vehicle, it may be possible to charge an electric energy storage device of a vehicle without charging cords and without having to find a location for a charging port that is not likely to be obstructed from time to time. Further, the tail lift allows the receiving coil to be oriented vertically so that it may be electromagnetically coupled to a charging coil that is vertically oriented. The vertically oriented coils may reduce a possibility of having to clear ice and snow from the coils to enable charging of the electric energy storage device. Further, the vehicle may be charged while a platform that the receiving coil is coupled to is used to ease access to the vehicle (e.g., while the vehicle is parked at a loading dock).

The present description may provide several advantages. Specifically, the approach may increase availability for charging electric energy storage devices of a vehicle. Further, the approach may reduce a possibility of humans and machines that load the vehicle interfering with vehicle charging. In addition, the approach may lower maintenance for EVSE and vehicle charging systems. Further still, the approach allows the vehicle to charge while the vehicle is being loaded at a loading dock.

The above advantages and other advantages, and features of the present description will be readily apparent from the following Detailed Description when taken alone or in connection with the accompanying drawings.

Referring to FIG. 1, a non-limiting example vehicle propulsion system 100 for vehicle 121 is shown. A front portion of vehicle 121 is indicated at 110 and a rear portion of vehicle 121 is indicated at 111. Vehicle propulsion system 100 includes a rear electric machine 126. However, in other examples, vehicle 121 may include two or more electric machines. Electric machine 126 may consume or generate electrical power depending on its operating mode. Throughout the description of FIG. 1, mechanical connections between various components are illustrated as solid lines, whereas electrical connections between various components are illustrated as dashed lines. Longitudinal and lateral directions are indicated at 199.

Vehicle propulsion system 100 includes a front axle 133 and a rear axle 122. In some examples, rear axle may comprise two half shafts, for example first half shaft 122a, and second half shaft 122b. Vehicle propulsion system 100 further has front wheels 130 and rear wheels 131. Rear wheels 131 may be driven via electric machine 126 and front wheels 130 are not driven.

The rear axle 122 is coupled to electric machine 126. Rear drive unit 136 may transfer power from electric machine 126 to axle 122 resulting in rotation of drive wheels 131. Rear drive unit 136 may include a low gear set 175 and a high gear 177 that are coupled to electric machine 126 via output shaft 126a of rear electric machine 126. Low gear 175 may be engaged via fully closing low gear clutch 176. High gear 178 may be engaged via fully closing high gear clutch 178. High gear clutch 178 and low gear clutch 176 may be opened and closed via commands received by rear drive unit 136 over CAN 299. Alternatively, high gear clutch 178 and low gear clutch 176 may be opened and closed via digital outputs or pulse widths provided via control system 14. Rear drive unit 136 may include differential 128 so that torque may be provided to axle 122a and to axle 122b. In some examples, an electrically controlled differential clutch (not shown) may be included in rear drive unit 136.

Electric machine 126 may receive electrical power from onboard electrical energy storage device 132 (e.g., a traction battery or a battery that provides power for propulsive effort of a vehicle). Furthermore, electric machine 126 may provide a generator function to convert the vehicle's kinetic energy into electrical energy, where the electrical energy may be stored at electric energy storage device 132 for later use by the electric machine 125 and/or electric machine 126. An inverter system controller (ISC) 134 may convert alternating current (AC) generated by rear electric machine 126 to direct current (DC) for storage at the electric energy storage device 132 and vice versa. Electric energy storage device 132 may be a battery, capacitor, inductor, or other electric energy storage device.

Electric energy storage device 132 may be supplied with electric charge from a stationary power grid 148 via EVSE 191 that includes a charging coil (not shown). The charging coil may supply electromagnetic energy to receiving coil 142, which is mechanically coupled to tail lift 140. Tail lift 140 (as shown in greater detail in FIGS. 2-5) may lift from earth level up to a level of a vehicle bed. Tail lift 140 includes rubber boot 141 that is configured to at least partially encircle receiving coil 142, thereby isolating the receiving coil from objects and living creatures (e.g., mammals). Electric charge may be transferred from receiving coil 142 to charger 143 (e.g., an alternating current (AC) to direct current (DC) converter. Alternatively, in some examples, receiving coil 142 may be coupled to inverter 134 to convert AC power into DC power.

Control system 14 may communicate with one or more of electric machine 126, energy storage device 132, charger 143, EVSE 191 via cellular network 189. Control system 14 may receive sensory feedback information from one or more of electric machine 126, energy storage device 132, charger 143, etc. Further, control system 14 may send control signals to one or more of charger 143, electric machine 126, energy storage device 132, etc., responsive to this sensory feedback. Control system 14 may receive an indication of an operator requested output of the vehicle propulsion system from a human operator 102, or an autonomous controller 155. For example, control system 14 may receive sensory feedback from pedal position sensor 194 which communicates with driver demand pedal 192. Pedal 192 may refer schematically to a driver demand pedal. Similarly, control system 14 may receive an indication of an operator requested vehicle braking via a human operator 102, or an autonomous controller 155. For example, control system 14 may receive sensory feedback from pedal position sensor 157 which communicates with brake pedal 156.

Electric energy storage device 132 includes an electric energy storage device controller 139 and a power distribution module 138. Electric energy storage device controller 139 may provide charge balancing between energy storage element (e.g., battery cells) and communication with other vehicle controllers (e.g., controller 12). Power distribution module 138 controls flow of power into and out of electric energy storage device 132.

One or more wheel speed sensors (WSS) 195 may be coupled to one or more wheels of vehicle propulsion system 100. The wheel speed sensors may detect rotational speed of each wheel. Such an example of a WSS may include a permanent magnet type of sensor.

Controller 12 may comprise a portion of a control system 14. In some examples, controller 12 may be a single controller of the vehicle. Control system 14 is shown receiving information from a plurality of sensors 16 (various examples of which are described herein) and sending control signals to a plurality of actuators 81 (various examples of which are described herein). As one example, sensors 16 may include tire pressure sensor(s) (not shown), wheel speed sensor(s) 195, light detecting and ranging (LIDAR) sensors, radio detecting and ranging (RADAR) sensors, cameras, sonic sensors, etc. In some examples, sensors associated with charger 143, electric machine 126, wheel speed sensor 195, etc., may communicate information to controller 12, regarding various states of electric machine operation. Controller 12 includes non-transitory memory (e.g., read-only memory) 165, random access memory 166, digital inputs/outputs 168, and a microcontroller 167.

Vehicle propulsion system 100 may also include an on-board navigation system 17 (for example, a Global Positioning System) on dashboard 19 that an operator of the vehicle may interact with. The navigation system 17 may include one or more location sensors for assisting in estimating a location (e.g., geographical coordinates) of the vehicle. For example, on-board navigation system 17 may receive signals from GPS satellites 33, and from the signal identify the geographical location of the vehicle. In some examples, the geographical location coordinates may be communicated to controller 12. The navigation system may also break a travel route into an actual total number of segments so that vehicle operation in the segments may be predicted. Navigation system 17 may communicate data from the travel route to controller 12.

Dashboard 19 may further include a display system 18 configured to display information to the vehicle operator. Display system 18 may comprise, as a non-limiting example, a touchscreen, or human machine interface (HMI), display which enables the vehicle operator to view graphical information as well as input commands. In some examples, display system 18 may be connected wirelessly to the internet (not shown) via controller (e.g. 12). As such, in some examples, the vehicle operator may communicate via display system 18 with an internet site or software application (app).

Dashboard 19 may further include an operator interface 15 via which the vehicle operator may adjust the operating status of the vehicle. Specifically, the operator interface 15 may be configured to initiate and/or terminate operation of the vehicle driveline (e.g., electric machine 125 and electric machine 126) based on an operator input. Various examples of the operator ignition interface 15 may include interfaces that utilize a physical apparatus, such as a key, that may be inserted into the operator interface 15 to start the electric machine 126 and to turn on the vehicle, or may be removed to shut down the electric machine 126 to turn off the vehicle. Still other examples may additionally or optionally use a start/stop button that is manually pressed by the operator to start or shut down the electric machine 126 to turn the vehicle on or off. In other examples, a remote electric machine start may be initiated remote computing device (not shown), for example a cellular telephone, or smartphone-based system where a user's cellular telephone sends data to a server and the server communicates with the controller 12 to start the engine.

Vehicle 121 may also include an audio system 185 that may include speakers and horns to provide audible information to vehicle occupants and people that may be outside of the vehicle. The audio system may generate audible messages to indicate vehicle status and to request feedback by humans before actions may be performed. For example, the audio system may request that people within a predetermined area (e.g., within 3 meters of the vehicle) leave the area before charging of the vehicle's electric energy storage device may begin or continue.

Referring to FIG. 2, a schematic representation of a rear view of vehicle 121 is shown. Vertical and horizontal directions are indicated at 299.

Vehicle 121 is shown with tail lift 140 having its platform 215 oriented in a vertical direction, which is suitable for when the vehicle is traveling or when the vehicle's electric energy storage device is being charged via a vertically oriented charging coil (not shown). Charging of the electric energy device via the vertical receiving and charging coils may reduce cleaning of the same since water and snow may tend to drip from the coils when the coils are vertically oriented as shown. Platform 215 may be of metallic construction so that it may shield other devices from electro-magnetic energy when the electric energy storage device is being charged. Receiving coil 142 is coupled to platform 215. Receiving coil 142 is also shown centrally located with respect to platform 215, but receiving coil may be moved left or right if desired. Rubber boot 141 is shown encircling at least a portion of receiving coil 142. Receiving coil 142 includes a hole 212 and a central axis 210. Central axis 210 passes through the center of hole 212 and central axis 210 is parallel to earth 250.

Vehicle 121 is also shown with two sensors. In one example, sensor 202 may be a camera and sensor 204 may be a ranging sensor (e.g., LIDAR or RADAR). Sensor 202 is shown attached to cargo box 266 while sensor 204 is shown directly coupled to platform 215. It may be appreciated that sensor 202 and sensor 204 may both be mounted to cargo box 266 or to platform 215. Further, in some examples, sensor 202 may be a ranging sensor and sensor 204 may be a camera depending on vehicle configuration and vehicle requirements. Platform 214 may be moved up and down in the vertical direction while in the vertical orientation.

Referring now to FIG. 3, a second schematic representation of a rear view of vehicle 121 is shown. Vertical and horizontal directions are indicated at 399.

Vehicle 121 is shown with tail lift 140 having its platform 215 oriented in a horizontal direction, which is suitable for when the vehicle is unloading or when the vehicle's electric energy storage device is being charged via a horizontally oriented charging coil (not shown). Charging of the electric energy device via the horizontal receiving and charging coils may allow charging coils to be placed in pavement and parking locations where it may be convenient to charge the electric energy storage device. Receiving coil 142 moves with platform 215 such that receiving coil 142 moves horizontally when platform 215 changes to a horizontal orientation. Rubber boot 141 is shown in a position to form a seal between earth 250 and platform 215 when platform 215 is move further in a downward direction. Central axis 210 is perpendicular to earth 250 when platform 215 is in its horizontal orientation.

Sensor 204 has been reoriented such that it may determine a distance from platform 215 and receiving coil 142 to earth 250. Platform 215 may move up and down in the vertical direction via tail lift 140 while in the horizontal orientation.

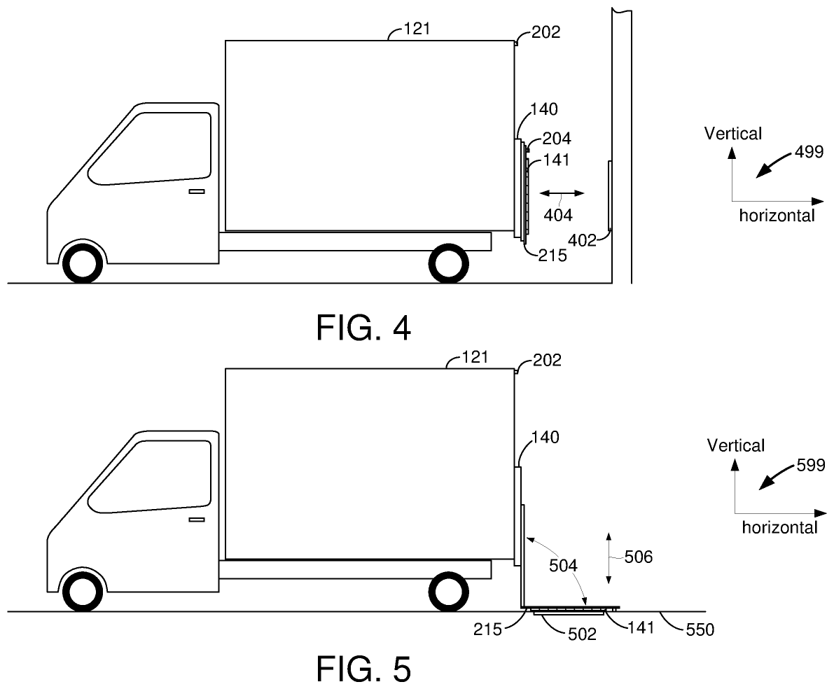

Referring now to FIG. 4, a first schematic representation of a side view of vehicle 121 is shown. Vertical and horizontal directions are indicated at 499.

Vehicle 121 is shown with tail lift 140 having its platform 215 oriented in a vertical direction. Platform 215 and attached receiving coil (not shown) may move as indicated by arrow 404 to become proximate to charging coil 402 so that inductive charging may commence. Further, tail lift 140 may move receiving coil vertically to align with charging coil 402. In some examples, charging coil 402 may move vertically, horizontally, and laterally to increase transfer of charge from charging coil 402 to the receiving coil (not shown). Rubber boot 141 may be positioned to cover and encircle charging coil 402 to prevent material, mammals, and objects from coming between charging coil 402 and receiving coil (not shown). Sensor 202 and sensor 204 may output information to aid the positioning of rubber boot 141 relative to charging coil 402. Additionally, platform 215 may be moved up or down vertically to aid in placement of rubber boot 141 relative to charging coil 402. Charging coil 402 and receiving coil (not shown) are in a vertical orientation.

Referring now to FIG. 5, a second schematic representation of a side view of vehicle 121 is shown. Vertical and horizontal directions are indicated at 599.

Vehicle 121 is shown with tail lift 140 having its platform 215 oriented in a horizontal direction. Platform 215 and attached receiving coil (not shown) may move vertically as indicated by arrow 506 via tail lift 140. Further, platform 215 has been rotated through angle 504 (e.g., 90 degrees) to position rubber boot 141, platform 215, and receiving coil 142 (not shown) in a horizontal orientation. In this example, charging coil 502 is in a horizontal orientation and fastened to pavement 550. Sensor 202 and sensor 204 may output information to aid the positioning of rubber boot 141 relative to charging coil 402.

Thus, the system of FIGS. 1-5 provides for a vehicle charging system, comprising: a vehicle including an electric energy storage device; and a tail lift including a receiving coil for charging the electric energy storage device. In a first example, the vehicle charging system includes where the tail lift is configured to lift and rotate a platform. In a second example that may include the first example, the vehicle charging system includes where the platform is fabricated of a metal. In a third example that may include one or both of the first and second examples, the vehicle charging system includes where the receiving coil is coupled to the platform. In a fourth example that may include one or more of the first through third examples, the vehicle charging system further comprises a rubber boot that encircles at least a portion of the receiving coil and extends from the platform. In a fifth example that may include one or more of the first through fourth examples, the vehicle charging system includes where the tail lift is positioned at a rear side of a vehicle. In a sixth example that may include one or more of the first through fifth examples, the vehicle charging system includes where the receiving coil is electrically coupled to a power conversion device. In a seventh example that may include one or more of the first through sixth examples, the vehicle charging system includes where the power conversion device is an inverter or an AC to DC converter.

The system of FIGS. 1-5 also provides for a vehicle charging system, comprising: a vehicle including an electric energy storage device; a tail lift including a receiving coil for charging the electric energy storage device; and a visual aid for positioning the tail lift proximate to charging coil. In a first example, the vehicle charging system includes where the visual aid includes a virtual representation of the receiving coil. In a second example that may include the first example, the vehicle charging system includes where the virtual representation of the receiving coil is based on available positions of the tail lift. In a third example that may include one or both of the first and second examples, the vehicle charging system further comprises an autonomous driver configured to place the receiving coil within a predetermined distance of the charging coil. In a fourth example that may include one or more of the first through third examples, the vehicle charging system further comprises sensors (e.g., LIDAR, RADAR, camera, sonic, etc.) to locate the charging coil.

The system of FIGS. 1-5 also provides for a vehicle charging system, comprising: a vehicle including an electric energy storage device; a tail lift including a receiving coil for charging the electric energy storage device; and a controller including executable instructions that prevent the tail lift and the vehicle from moving while the electric energy storage device is receiving charge via the receiving coil. In a first example, the vehicle charging system includes where the vehicle is prevented by moving via preventing gear engagement or engaging a parking brake. In a second example that may include the first example, the vehicle charging system includes where the tail lift is prevented from moving via commanding the tail lift locked. In a third example that may include one or more of the first through third examples, the vehicle charging system further comprises additional executable instructions that cease charging of the electric energy device or prevent charging of the electric energy storage device in response to one or more persons being within a predetermined area of the vehicle. In a fourth example that may include one or more of the first through third examples, the vehicle charging system further comprises additional instructions to provide an audible message to the one or persons to leave the predetermined area.

Referring now to FIG. 6, a depiction 600 of an example human/machine interface display for aligning a receiving coil with a charging coil is shown. In this example, depiction 600 includes a visualization of charging coil 650 and virtual receiving coil 604. Virtual receiving coil 604 is shown in a position if the platform 215 of the tail lift 140 was in a horizontal orientation. The actual receiving coil does not have to be in a horizontal orientation for the position of the virtual receiving coil 604 to be displayed.

In this example, the position of virtual receiving coil is shown in a position approaching charging coil 650 and the virtual receiving coil 604 and the charging coil 650 are in a horizontal orientation. A human or autonomous driver may adjust a position of the vehicle as indicated by arrow 610 to position the virtual receiving coil 604 proximate to charging coil 650. Once the virtual receiving coil 604 is proximate to charging coil 650, the actual receiving coil may be moved to be proximate to the charging coil 650 by adjusting the position of the receiving coil via the tail lift. Vehicle trajectory indication guides 602 provide an indication of the vehicle's current trajectory to aid the driver to orient the virtual receiving coil 604 relative to the charging coil 650.

Referring now to FIG. 7, a second depiction 700 of an example human/machine interface display for aligning a receiving coil with a charging coil is shown. In this example, depiction 700 includes a visualization of charging coil 750 and virtual receiving coil 704. Virtual receiving coil 704 is shown in a position with the platform 215 of the tail lift 140 in a vertical orientation.

In this example, the position of virtual receiving coil is shown in a position approaching charging coil 750 and the virtual receiving coil 704 and the charging coil 750 are in a vertical orientation. A human or autonomous driver may adjust a position of the vehicle as indicated by arrow 710 to position the virtual receiving coil 704 proximate to charging coil 750. Once the virtual receiving coil 704 is proximate to charging coil 750, the actual receiving coil may be moved to be proximate to the charging coil 750 by adjusting the position of the receiving coil via the tail lift. Vehicle trajectory indication guides 702 provide an indication of the vehicle's current trajectory to aid the driver to orient the virtual receiving coil 704 relative to the charging coil 750.

Referring now to FIG. 8, a method for charging an electric energy storage device via a tail lift of a vehicle is shown. The method of FIG. 8 may be included in the system of FIGS. 1-5 as executable instructions stored in non-transitory memory. Further still, portions of the method of FIG. 8 may be actions taken in the physical world by a controller and/or a human.

At 802, method 800 determines vehicle operating conditions. Vehicle operating conditions may include but are not limited to electric energy storage device state of charge (SOC), vehicle position, ambient air temperature, vehicle mass, and vehicle travel route. Method 800 proceeds to 804.

At 804, method 800 judges whether or not the present electric energy storage device SOC is greater than a threshold SOC. Alternatively, or in addition, method 800 may judge whether or not the present SOC is insufficient for the vehicle to reach its destination according to the vehicle travel route. If the SOC is less than a threshold, the answer is yes and method 800 proceeds to 806. Alternatively, if SOC is insufficient for the vehicle to reach its destination, the answer is yes and method 800 proceeds to 806. Otherwise, the answer is no and method 800 proceeds to 840.

At 840, method 800 continues vehicle operation without scheduling recharging. The vehicle may respond to driver demands and travel it its intended destination. Method 800 exits.

At 806, method 800 maps a travel route to an acceptable EVSE. Acceptable EVSE may include commercial for profit chargers and private fleet charging EVSE. The vehicle's navigation system generates a travel route to the EVSE destination.

At 808, the vehicle is driven to the EVSE. The vehicle may be driven via a human driver or an autonomous driver. The driver may approach a designated, assigned, or open EVSE. Method 800 proceeds to 810.

At 810, method 800 judges whether or not the area proximate to the charging coil is free of debris, mammals, objects, etc. that may interfere with charging. In one example, vehicle sensors combined with the vehicle controller may make an assessment whether or not the area proximate to the vehicle and the charging coil is free of interference. If so, the answer is yes and method 800 proceeds to 812. If not, the answer is no and method 800 proceeds to 850.

If people are in the area, method 800 may display a message or indicate to the people that they need to leave the immediate area before charging may begin. The indication may also include an audible indication via a speaker, horn, or other device.

At 850, method 800 indicates that there is an obstruction that has to be cleared before charging of the vehicle's electric energy storage device may commence. Method 800 returns to 810.

At 812, method 800 applies vehicle systems (e.g., sensors, actuator, controllers, autonomous drivers, etc.) to align the vehicle with the charging coil of the EVSE. In one example, a vehicle camera may provide an indication of the charging coil and a position of a virtual receiving coil relative to the charging coil (e.g., the displays of FIGS. 6 and 7) so that a human driver or autonomous driver may move the vehicle to a position that is proximate to the charging coil. Method 800 proceeds to 814.

At 814, method 800 applies vehicle systems to align the receiving coil with the charging coil of the EVSE. In one example, method 800 may apply cameras, range sensing devices, etc. to judge whether or not the receiving coil is to be moved relative to the charging coil of the EVSE. If the receiving coil is not within a predetermined range (e.g., lateral distance, vertical distance, and longitudinal distance) of the charging coil, method 800 may adjust the position of the platform 215 so that the receiving coil is within a specified range of the charging coil. If the receiving coil is not within the specified range of the charging coil, the tail lift may pivot its platform or raise or lower the platform to position the receiving coil within the specified range of the charging coil. Method 800 proceeds to 816.

At 816, method 800 optionally requests that the charging coil is moved to bring the charging coil within the specified range or distance of the receiving coil. In one example, the vehicle controller may communicate to a controller of the charging coil (EVSE) to request movement of the charging coil (e.g. vertical, lateral, longitudinal). The communication may be via a cellular network, wireless, or satellite. Method 800 proceeds to 818.

At 818, method 800 places the receiving coil perimeter cover (e.g., rubber boot) over the charging coil to seal an area between the charging coil and the receiving coil. Method 800 proceeds to 820.

At 820, method 800 exchanges data with the EVSE to confirm payment and/or permission to receive charge from the charging coil. Data exchanged may include but is not limited to vehicle identification, payment method, security code, ect. Method 800 proceeds to 822.

At 822, method 800 prepares the vehicle for charging. Preparation may include but is not limited to locking the vehicle's transmission in park and locking the position of the tail lift. The tail lift may be locked via sending a message to the tail gate to lock or via preventing electric current flow to the tail lift. Method 800 proceeds to 824.

At 824, method 800 receives charge from the EVSE via the receiving coil. The receiving coil may deliver the charge to a charger or inverter so that DC power may be delivered to the electric energy storage device. Method 800 proceeds to 826.

At 826, method 800 judges whether or not the charging efficiency is greater than a threshold efficiency. If so, the answer is yes and method 800 proceeds to 828. Otherwise, the answer is no and method 800 proceeds to 835. Charging efficiency that is less than a threshold efficiency may be indicative of improper placement of the receiving coil, an obstruction between the charging coil and receiving coil, or an inoperative charging coil.

At 835, method 800 commands the EVSE to cease charging and method 800 requests inspection of the charging system to determine if degradation is present. The request for inspection may be broadcast or displayed on a human/machine interface. Method 800 proceeds to exit.

At 828, method 800 judges whether or not the SOC of the electric energy storage device is greater than a threshold SOC. If so, the answer is yes and method 800 proceeds to 830. Further, charging ceases. Otherwise, the answer is no and method 800 returns to 828.

At 830, method 800 repositions the platform and receiving coil into a vertical orientation to prepare the vehicle for movement. If the vehicle is driven via an autonomous driver, the vehicle may proceed to a new destination or be parked elsewhere to free up EVSE. Method 800 proceeds to exit.

In this way, method 800 may position a receiving coil to receive charge from EVSE. The positioning may include moving a vehicle and/or moving a tail lift. The tail lift may move vertically and pivot so as to enable charging in horizontal and vertical orientations.

The method of FIG. 8 provides for a method for operating a method for charging an electric energy storage device of a vehicle, comprising: adjusting a position of a tail lift relative to a charging coil; receiving electric charge from the charging coil to a receiving coil, the receiving coil mechanically coupled to the tail lift. In a first example, the method includes where adjusting the position of the tail lift includes adjusting a vertical position of the tail lift. In a second example that may include the first example, the method includes where adjusting the position of the tail lift includes adjusting a horizontal position of the tail lift. In a third example that may include one or both of the first and second examples, the method includes where during charging of the electric energy storage device, the receiving coil is arranged in a vertical position with an axis passing through a center region of the receiving coil being parallel with earth. In a fourth example that may include one or more of the first through third examples, the method includes where during charging of the electric energy storage device, the receiving coil is arranged in a vertical position with an axis passing through a center region of the receiving coil being perpendicular with earth. In a fifth example that may include one or more of the first through fourth examples, the method includes where adjusting the position of the tail lift includes moving the tail lift to the charging coil with aid of one or more sensors coupled to the vehicle. In a sixth example that may include one or more of the first through fifth examples, the method includes where vehicle is moved via an autonomous driver.

In another representation, the method of FIG. 8 also provides for a method for charging an electric energy storage device of a vehicle, comprising: communicating a request to adjust a position of a charging coil; receiving electric charge from the charging coil to a receiving coil, the receiving coil mechanically coupled to the tail lift. The method includes where the charging coil is part of EVSE. The method includes where the request indicates vertical and/or horizontal movement of the charging coil.

As will be appreciated by one of ordinary skill in the art, methods described in FIG. 4 may represent one or more of any number of processing strategies such as event-driven, interrupt-driven, multi-tasking, multi-threading, and the like. As such, various steps or functions illustrated may be performed in the sequence illustrated, in parallel, or in some cases omitted. Likewise, the order of processing is not necessarily required to achieve the objects, features, and advantages described herein, but is provided for ease of illustration and description. Although not explicitly illustrated, one of ordinary skill in the art will recognize that one or more of the illustrated steps or functions may be repeatedly performed depending on the particular strategy being used. Further, the methods described herein may be a combination of actions taken by a controller in the physical world and instructions within the controller. At least portions of the control methods and routines disclosed herein may be stored as executable instructions in non-transitory memory and may be carried out by the control system including the controller in combination with the various sensors, actuators, and other system hardware.

This concludes the description. The reading of it by those skilled in the art would bring to mind many alterations and modifications without departing from the spirit and the scope of the description. For example, the systems and methods described herein may be applied to full electric vehicles and vehicles that include an engine and an electric motor for propulsion.

1. A vehicle charging system, comprising:
a vehicle including an electric energy storage device; and
a tail lift including a receiving coil for charging the electric energy storage device.

2. The vehicle charging system of claim 1, where the tail lift is configured to lift and rotate a platform.

3. The vehicle charging system of claim 2, where the platform is fabricated of a metal.

4. The vehicle charging system of claim 3, where the receiving coil is coupled to the platform.

5. The vehicle charging system of claim 4, further comprising a rubber boot that encircles at least a portion of the receiving coil and extends from the platform.

6. The vehicle charging system of claim 1, where the tail lift is positioned at a rear side of the vehicle.

7. The vehicle charging system of claim 6, where the receiving coil is electrically coupled to a power conversion device.

8. The vehicle charging system of claim 7, where the power conversion device is an inverter or an AC to DC converter.

9. A method for charging an electric energy storage device of a vehicle, comprising:
adjusting a position of a tail lift relative to a charging coil;
receiving electric charge from the charging coil to a receiving coil, the receiving coil mechanically coupled to the tail lift.

10. The method of claim 9, where adjusting the position of the tail lift includes adjusting a vertical position of the tail lift.

11. The method of claim 9, where adjusting the position of the tail lift includes adjusting a horizontal position of the tail lift.

12. The method of claim 9, where during charging of the electric energy storage device, the receiving coil is arranged in a vertical position with an axis passing through a center region of the receiving coil being parallel with earth.

13. The method of claim 9, where during charging of the electric energy storage device, the receiving coil is arranged in a vertical position with an axis passing through a center region of the receiving coil being perpendicular with earth.

14. The method of claim 9, where adjusting the position of the tail lift includes moving the tail lift to the charging coil with aid of one or more sensors coupled to the vehicle.

15. The method of claim 14, where vehicle is moved via an autonomous driver.

16. A vehicle charging system, comprising:
a vehicle including an electric energy storage device;
a tail lift including a receiving coil for charging the electric energy storage device; and
a controller including executable instructions that prevent the tail lift and the vehicle from moving while the electric energy storage device is receiving charge via the receiving coil.

17. The vehicle charging system of claim 16, where the vehicle is prevented by moving via preventing gear engagement or engaging a parking brake.

18. The vehicle charging system of claim 17, where the tail lift is prevented from moving via commanding the tail lift locked.

19. The vehicle charging system of claim 16, further comprising additional executable instructions that cease charging of the electric energy device or prevent charging of the electric energy storage device in response to one or more persons being within a predetermined area of the vehicle.

20. The vehicle charging system of claim 19, further comprising additional instructions to provide an audible message to the one or persons to leave the predetermined area.
